(19) United States
(12) Patent Application Publication
(10) Pub. No.: US 2024/0429649 A1
(43) Pub. Date: Dec. 26, 2024

(54) Socket Housing and Socket

(71) Applicants: Tyco Electronics (Suzhou) Ltd., Suzhou City (CN); Tyco Electronics Technology (SIP) Ltd., Suzhou (CN); Tyco Electronics (Shanghai) Co., Ltd., Shanghai (CN)

(72) Inventors: Jianwei Qi, Suzhou (CN); Jinshun (Jet) Wang, Suzhou (CN); Fangyue (Jason) Zhu, Shanghai (CN)

(73) Assignees: Tyco Electronics (Suzhou) Ltd., Suzhou City (CN); Tyco Electronics Technology (SIP) Ltd., Suzhou (CN); Tyco Electronics (Shanghai) Co., Ltd., Shanghai (CN)

(21) Appl. No.: 18/747,628

(22) Filed: Jun. 19, 2024

(30) Foreign Application Priority Data
Jun. 20, 2023 (CN) 202321584113.1

(51) Int. Cl. H01R 13/52; B60L 53/16

(52) U.S. Cl. CPC H01R 13/5227; B60L 53/16; H01R 2201/26

(57) ABSTRACT

A socket housing includes a base portion and a first wall portion formed as a hollow cylindrical wall that protrudes continuously from a first side of the base portion. The first wall portion has a first drainage portion intersecting the base portion and opening outwards. The first drainage portion is a passage that extends obliquely from an inner root portion of the first wall portion to an outer root portion of the first wall portion.

### CROSS-REFERENCE TO RELATED APPLICATIONS

This application claims the benefit of the filing date under 35 U.S.C. § 119 (a)-(d) of Chinese Patent Application No. 202321584113.1, filed on Jun. 20, 2023.

### FIELD OF THE INVENTION

The present disclosure relates to a socket housing and a socket, in particular to a socket housing and a socket used for charging an electric vehicle.

### BACKGROUND OF THE INVENTION

A socket is used for a plug-in mating with a paired electronic device so as to implement an electrical connection therebetween. An electric vehicle is commonly equipped with a charging socket for matching with an external charging gun. A charging socket typically comprises a socket housing, a terminal mounting base, and terminals. The terminal mounting base is fixedly installed in the socket housing, and the terminals are installed in the terminal mounting base. A housing of the charging socket is fixed to sheet metal of a vehicle body. In order to charge an electric vehicle, a charging plug (or alternatively known as a charging gun) of a charging pile is generally inserted into the socket provided on the vehicle body of the electric vehicle so as to implementing the charging.

As more electric vehicles are put into operation, improving safety performance of electric vehicle upon charging is increasingly important. Due to the complexity of the application scenario, when a charging socket is used outdoors, the electric vehicle tends to go through adverse environmental conditions such as rain, humidity, and water sputtering, and the like, which often leads to a risk of water accumulation inside the charging plug and in turn a water immersion inside the housing of the charging plug. When the water entering the charging socket is not discharged timely but instead accumulates to a certain extent, for example, metal oxidation in the conductive hole of the charging socket may be accelerated by water accumulation, resulting in a poor contact between charging terminals of the charging gun and conductive holes of the charging socket, which leads to heat generation between the charging gun and the charging socket during the charging. Additionally, or alternatively, a short circuiting may be caused by water accumulation, which may damage the charging gun and the charging socket, thus posing a potential safety hazard onto the electric vehicle.

In order to prevent water from accumulating in an inner cavity of the terminal mounting base, a drainage hole which opens towards a side of the vehicle body where the sheet metal is located, is typically formed on a peripheral wall of the terminal mounting base, and the water in the inner cavity is directly discharged through the interior of the housing and enters a drainage fitting (such as a corrugated pipe and the like) which is placed inside the vehicle body and in waterproof communication with the drainage hole. However, in some applications, the discharged water cannot enter the interior of the vehicle body on the side thereof where the sheet metal is located and, due to limitations in terms of shape and dimension of the space for installation, an existence of excessive redundant accessories is not allowed, which in turn limits the application of the existing charging socket.

### SUMMARY OF THE INVENTION

A socket housing includes a base portion and a first wall portion formed as a hollow cylindrical wall that protrudes continuously from a first side of the base portion. The first wall portion has a first drainage portion intersecting the base portion and opening outwards. The first drainage portion is a passage that extends obliquely from an inner root portion of the first wall portion to an outer root portion of the first wall portion.

### BRIEF DESCRIPTION OF THE DRAWINGS

The accompanying drawings, which are incorporated in and constitute a portion of the specification, illustrate certain aspects of the subject matter disclosed herein and, together with the description, facilitate interpreting some principles associated with the embodiments as disclosed. In the attached drawings:

FIG. 1A is a schematic perspective view of a socket housing according to an embodiment;

FIG. 1B is a schematic front view of the socket housing;

FIG. 2 is a sectional side view of the socket housing, taken along line A-A of FIG. 1B;

FIG. 3 is a partial enlargement view of an area O of FIG. 2;

FIG. 4A is a schematic right view of a socket according to an embodiment; and

FIG. 4B is a schematic perspective view of the socket of FIG. 4A.

### DETAILED DESCRIPTION

The present disclosure will be described in detail with reference to the accompanying drawings, which are provided as illustrative examples of the disclosure for those skilled in the art to practice the disclosure. It is worth noting that the following drawings and examples are intended to make other embodiments possible by an interchange of some or all of the elements as described or as illustrated, rather than intending to restrict the scope of this disclosure to merely a single embodiment. Furthermore, in a condition that some elements of the present disclosure can be partially or completely implemented using known components, merely those portions of such known components that are necessary for understanding the present disclosure will be described, and detailed descriptions of other portions of such known components will be omitted so as to avoid confusion with the present disclosure.

Unless otherwise specified herein, those skilled in the art will understand that embodiments described as implemented in software should not be limited to this but may include embodiments implemented in hardware or in a combination of software and hardware, and vice versa. In this specification, embodiments showing singular parts should not be considered as restrictive; however, unless explicitly stated otherwise herein, this disclosure is intended to cover other embodiments including a plurality of identical components, and vice versa. Furthermore, the applicant does not intend to attribute any terms in the specification or the claims to uncommon or special meanings, unless explicitly stated. In addition, this disclosure covers current and future known equivalent components of known components as mentioned herein by illustrations.

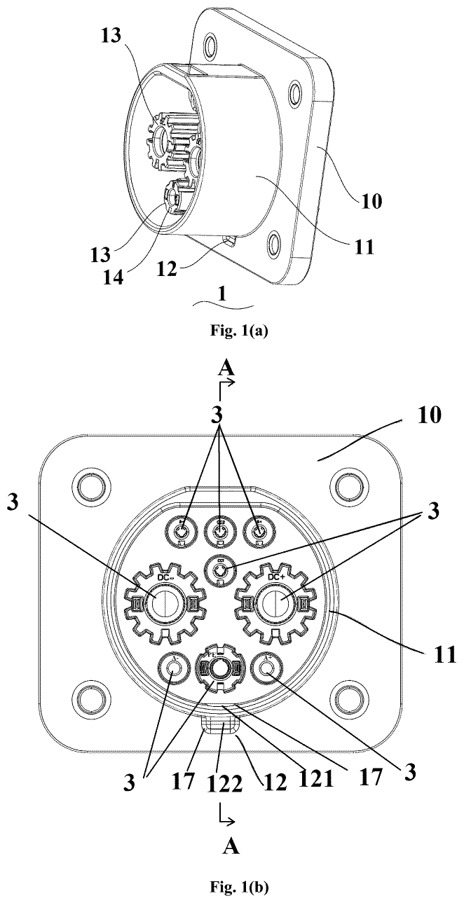

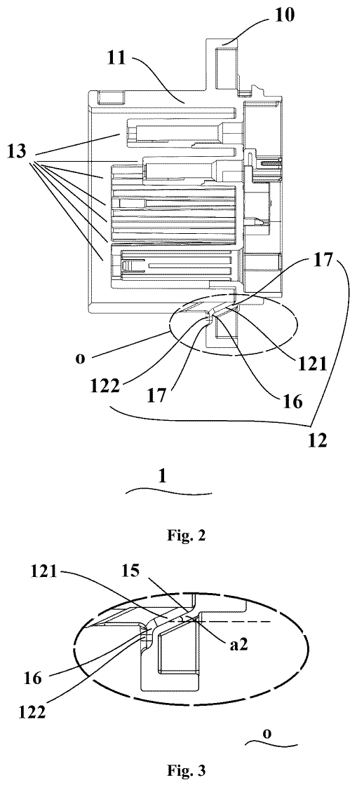

Unless otherwise specified, the terms “bottom” and “top,” “up/upper” and “down/lower” and the like as mentioned in contents as recorded in the utility model concerning the socket housing, are relative concepts. Specifically, the up and down directions as shown in FIGS. 1A, 1B, and 2 represent a respective top end and bottom end. That is to say, the accumulated water naturally slides down from top to bottom by gravity and is discharged. In this embodiment, an axial direction refers to a direction in which the first wall portion as illustrated in FIGS. 1A, 1B, and 2 protrudes. A circumferential direction refers to a direction of circumference as depicted in the figures.

According to a general technical concept of the present disclosure, in an aspect thereof, for example as shown in FIGS. 1A, 1B, and 2, there is provided a socket housing 1 suitable for the field of charging electric vehicles. In an embodiment, the socket housing 1 is used for coupling to a sheet metal component 4 of a vehicle body. By way of example, said socket housing 1 comprises: a base portion 10 and a first wall portion 11.

The first wall portion 11 is in the form of a hollow cylindrical wall that continuously protrudes from a first side of the base portion 10. The first wall portion 11 is provided with a first drainage portion 12 that intersects with the base portion 10 and opens outwards.

In an embodiment, the base portion 10 is, for example, fitted to and coupled with the vehicle body, on a second side opposite to the first side of the base portion 10. The second side of the base portion 10 is considered to be an installation side thereof to be mounted onto the vehicle body. In other words, by way of example, a surface on the second side of the base portion 10 is a reference surface on the installation side which is to be fitted and mounted to (for example the sheet metal component of) the vehicle body.

In an assembly of both the socket housing 1 and the sheet metal component, a relative positioning dimension and angle between the socket housing 1 and the sheet metal component is determined based on the surface on the second side of the base portion 10. In an exemplary embodiment, the base portion 10 is in the form of a flat plate shape, and the surface on the second side of the base portion 10 is a flat surface to be tightly abutted against for example the sheet metal component of the vehicle body and to be assembled together with the sheet metal component. As required, the second side of the base portion 10 is a side thereof that is expected to be isolated from and sealed relative to an external environment, e.g., moisture in the environment, that is to say, a dry side.

In an embodiment, the first drainage portion 12 is a passage which extends obliquely from an inner root portion of the first wall portion 11 to an outer root portion of the first wall portion 11, i.e., extending through the whole first wall portion 11. The first drainage portion 12 may be in the form of a passage which extends obliquely from the inner root portion of the first wall portion 11, through the whole first wall portion 11, to the outer root portion of the first wall portion 11, in a vertical plane where an axis of the first wall portion 11 is located. As such, for example, it facilitates implementation of a through passage which extends obliquely downwards from the inner root portion of the first wall portion 11 to the outer root portion at a lowest point of the first wall portion 11, thereby enabling the first drainage portion 12 to continuously penetrate the first wall portion 11 itself vertically and obliquely downwards. As such, the first drainage portion 12 of the first wall portion 11 intersects with a lowest portion of the base portion 10 and opens outward. In an embodiment, the first drainage portion 12 merely extends obliquely downward through the lowest portion of a side wall of the first wall portion 11, rather than extending to a free end of the first wall portion 11 (in other words, an axial extension range of the first drainage portion 12 in an axial direction of the first wall portion 11 does not extend to or beyond the free end of the first wall portion 11), and the first drainage portion 12 is configured to discharge water contained in the first wall portion 11 (for example, accumulated water in a space surrounded and circumscribed by both the first wall portion 11 and the base portion 10) to the outside of the socket housing 1. Here, the expression “intersects with a lowest portion of the base portion 10” is intended to indicate that the first drainage portion 12 is positioned to intersect with the lowest portion of the base portion 10.

The first wall portion 11 in the form of a hollow cylindrical wall protrudes from the first side of the base portion 10, and at the lowest portion of the base portion 10, the base portion 10 and the first wall portion 11 jointly define a lowest place in the socket housing 1 where the accumulated water is most easily collected. The first wall portion 11 interfaces with the base portion 10 at this lowest place. By way of example, the first drainage portion 11 is formed in any form of through passage communicating between the inner and outer sides of the socket housing 1, comprising a straight line shape, an arc shape, or a curve shape.

The aforementioned design enables migration/relocation of a drainage structure typically provided in a dry area where the sheet metal component 4 is located to outside of the dry area, without any additional fitting parts or any additional structures for facilitating water drainage (e.g., corrugated pipe connection), thereby decreasing difficulty in assembly, and quantity of components and parts, as well as manufacturing cost, without any necessity of consideration of spatial impact onto the dry area by the drainage structure. Further, it eliminates the adverse effect of residual moisture remaining in the socket 2 on the dry area where the sheet metal component 4 is located at a rear side of the socket housing 1.

In an embodiment, as shown in FIGS. 1A and 2, the socket housing 1 further comprises a plurality of second wall portions 13 which are surrounded by the first wall portion 11 and spaced apart from each other. Each second wall portion 13 is in the form of a hollow cylindrical wall protruding continuously from the first side of the base portion 10 and is configured to accommodate a respective one of a plurality of terminals 3, shown in FIG. 1B. Each second wall portion 13 defines an installation hole for mounting a respective one of the plurality of terminals 3.

In a further embodiment, each second wall portion 13 is provided with a respective second drainage portion 14 at an intersection thereof with the base portion 10, as shown in FIG. 1A. Each second drainage portion 14 is in the form of a passage which extends from an inner side to an outer side of a respective second wall portion 13, and each second drainage portion 14 continuously extends along an axial direction of the respective second wall portion 13 to a free end of the respective second wall portion 13.

In the socket housing 1, by providing the respective second drainage portion 14 on each of the plurality of second wall portions 13 which function as hole walls such that the respective second drainage portion 14 functions as an additional drainage structure for each terminal installation position, it enables discharge of accumulated water formed in such installation holes for the terminals 3 in conditions such as water droplets brought in by plug-in match of mating terminals and the like. Then, the discharged water can be further guided towards the first drainage portion 12, thereby providing a two-stage drainage passage, which may improve safety performance. In an embodiment, a respective mounting hole for each terminal 3 is provided at a bottom end of the respective second wall portion 13 in the vertical direction, then the accumulated water can be automatically discharged, by its own weight, into the space enclosed by the first wall portion 11 and the base portion 10, for being guided subsequently towards the first drainage portion 12 for further discharge, thereby improving drainage efficiency.

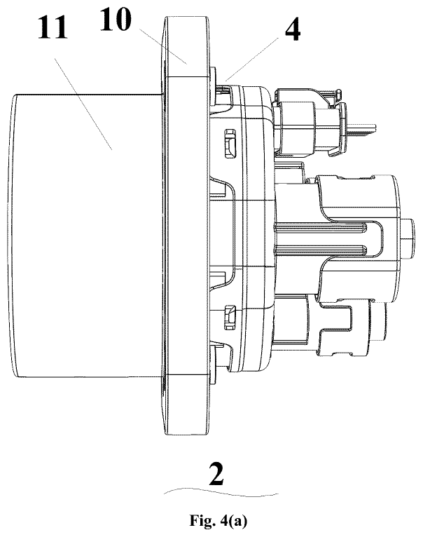

In a further embodiment, for example, as illustrated in FIG. 3, the first drainage portion 12 extends continuously from an inlet section 121, which is located at the inner root portion intersecting with the base portion 10, of the first wall portion 11 to an outlet section 122, which is located at the outer root portion intersecting with the base portion 10, of the first wall portion 11. The first drainage portion 12 comprises a plurality of channel sections coupled with each other, with an angle of each channel section relative to an axial direction of the first wall portion 11 gradually increasing from the inlet section 121 towards the outlet section 122.

In order to avoid the difficulty in draining the accumulated water, at a space jointly defined by both the first wall portion 11 and the base portion 10 (such space is considered to be a retention chamber for accumulated water), especially at a bottom end of the space, the first drainage portion 12 is typically set to intersect or connect with the base portion 10 of the socket housing 1, for example. In an embodiment, the first drainage portion 12 extends continuously from the inlet section 121 which is provided at the inner root portion of the first wall portion 11 intersecting with the base 10 to the outlet section 122 which is provided at the outer root portion of the first wall portion 11 intersecting with the base 10.

In the structure of the passage of the first drainage portion 12, by such a setting in which the angle of each channel section relative to the first wall portion 11 gradually increases, it enables the accumulated water in the space surrounded by the first wall portion 11 and the base portion 10 (especially at the inlet section 121 at the inner root portion of the first wall portion 11 intersecting with the base portion 10) to be accelerated naturally due to its gravity so as to flow out.

In an exemplary embodiment according to the present disclosure, for example, based on both radial dimension and circumferential dimension of the first wall portion 11, a cross-sectional dimension of the first drainage portion 12 may be determined. Specifically, by way of example, a square of a width of the first drainage portion 12 as illustrated is positively correlated with a flow rate of the drainage, and the radial dimension and the circumferential dimension of the first wall portion 11 are related to a volume to be drained and the flow rate of the drainage as required.

In an exemplary embodiment according to the present disclosure, for example, the inlet section 121 is provided with a groove which extends along the axial direction of the first wall portion 11 and has a cross section gradually increasing from an inner side towards an outer side of the first wall portion 11. By such an arrangement, both water passing area and drainage efficiency of the inlet section 121 increase.

In an embodiment, the inlet section 121 has typically a trapezoidal longitudinal section, for example. When the height of the drainage passage is predefined, by selecting the longitudinal section as a trapezoid shape, it may bring about a greater sectional area, i.e., optimally increase the water passing area, and may further improve the drainage efficiency. As such, the inlet section 121 of the drainage passage may have a trapezoidal longitudinal section to achieve an ever-increasing sectional area of the drainage passage (i.e., drainage trough) which extends along the axial direction of the first wall portion 11 from the inner side to the outer side thereof.

By setting the drainage passage at the inlet section 121 to be concave from top to bottom, for example, it may solve a problem of relatively large plugging and unplugging force caused by the difficulty in exhausting/discharging gas in the terminal portion during the plugging between the socket 2 and the charging gun in the prior, effectively reducing the plugging and unplugging force. At the same time, the water droplets condensed in terminal barrel or entering terminal hole due to the water droplets carried along with body of the charging gun, may be discharged timely through the drainage hole(s), so as to prevent water accumulation.

In an exemplary embodiment according to the present disclosure, a guide inclined surface 15 is for example provided at the bottom of the socket housing 1, as shown in FIG. 3. The guide inclined surface 15 is in the proximity of inlet section 121 of the first drainage portion 12, with a higher end of the guide inclined surface 15 being provided distal to the inlet section 121 and a lower end of the guide inclined surface 15 being provided proximal to the inlet section 121. By way of example, a height difference is formed between the higher end and the lower end by die-drawing/die-lifting process, thereby enabling proceeding to discharge moisture in the space surrounded by the first wall portion 11.

Furthermore, as shown in FIG. 1A to 3, in embodiments as illustrated, the outlet section 122 is for example provided in an inverted funnel shape having a cross-section which expands outwards. As such, according to Bernoulli's principle, such a setting facilitates dispersing the drained water with the inlet section 122 which is ever-increasing in cross-section at a slightly slower flow rate, thereby avoiding sputtering of the drained water at the outlet.

Moreover, as shown in FIGS. 1A to 3, in embodiments as illustrated, by way of

example, before the outlet section 122, the first drainage portion 12 has its cross-sectional area gradually shrinking from the inlet section 121 towards the outlet section 122. According to Bernoulli's principle, such a setting may assist in accelerating the flow rate inside the channel so as to promote drainage.

In the embodiment as illustrated, for example, the first drainage portion 12 is provided with a turning section 16 extending outwards before the outlet section 122, for example, such that the outlet section 122 is angled to be nearly perpendicular to the first wall portion 11, and drainage passage is in the form of a turning shape before reaching the outlet section 122, thereby preventing muddy water from sputtering into interior of the socket housing 1 of the charging socket from the outside. By such a turning, the muddy water sputters into essentially a “downspout,” and the muddy water may be hindered/obstructed at the position of the turning, such that the muddy water may not continue to proceed inwards to enter the socket 2, achieving an anti-sputtering effect.

As shown in FIG. 2, in the exemplary embodiment according to the present disclosure, rounded corners 17 are formed at edges of both the inlet portion 121 and the outlet portion 122, for example, to function as guide corners, thereby avoiding any sudden/sharp change in the flow state at sharp corners.

In an exemplary embodiment according to the present disclosure, for example, the outlet section 122 is additionally provided with a protective portion at least partially surrounding itself, for example a protective cap, so as to prevent foreign objects from entering or blocking the outlet section 122.

In an embodiment as illustrated, in order to reduce the manufacturing cost, for example, the base 10 and the first wall portion 11 are integrally molded plastic pieces, and the first drainage portion 12 is for example formed by molding or opening holes in the plastic. Similarly, by way of example, the plurality of second drainage portions 14 are formed by direct molding.

In order to improve sealing and waterproof performance of the socket housing 1, for example, the socket housing 1 further comprises a sealing component for example provided to surround the first wall portion 11 and/or each second wall portion 13. By way of example, the sealing component is, for example, provided with a sealing ring which extends in a circumferential direction of the socket housing 1 and in the form of a closed loop shape. The sealing component is, for example, a rubber ring. A specific shape of the sealing component merely requires implementing corresponding sealing.

Based on the socket housing 1 described above, by the first drainage portion 12 which is provided at the root portion of the first wall portion 11 intersecting with the base portion 10, the drainage structure can be migrated/relocated from a dry area of the sheet metal component 4, to outside of the dry area, so as to smoothly drain and discharge the accumulated water in the socket housing 1 to the outside of the housing 1 under its own gravity, without any additional fitting parts or any additional structures for facilitating water drainage (e.g., corrugated pipe connection). This decreases difficulty in assembly, and quantity of components and parts, as well as manufacturing cost, without spatial impact onto the dry area by the drainage structure. The design also avoids the accumulated water from flowing through or even flowing into installation socket(s) for terminal(s), in turn avoiding any adverse effect on the terminals. Moreover, specific settings on shape, dimension, and internal structure of the first drainage portion 12 effectively optimize the drainage, and also avoid adverse effect of foreign objects entering the outlet section 122.

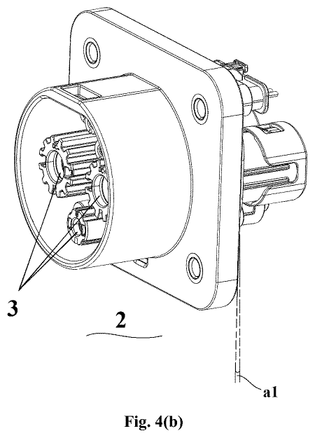

According to another embodiment, as shown in FIGS. 4A and 4B, there is also provided a socket 2 for coupling to a sheet metal component 4 of a vehicle body. The socket 2 comprises: the socket housing 1 as described in above embodiments, which is coupled to the sheet metal component 4 of the vehicle body, with a second side opposite to the first side of the base portion 10 being arranged towards the sheet metal component 4 and cooperatively coupled to the sheet metal component 4, a plurality of connection terminals 3, being accommodated in holes defined by the plurality of second wall portions 13 in one-to-one correspondence.

In an embodiment as illustrated, in order to reduce manufacturing costs, accordingly, each terminal is formed by a single blank plate through an integrated stamping process.

In order to improve robustness, stability and retention capacity of connection terminals, the socket 2 is provided with holes defined by the plurality of second wall portions 13 to function as installation holes for connection terminals 3. By way of example, the installation holes are provided in the axial direction of the socket housing 1.

In an embodiment, the socket housing 1 is a housing for the charging socket of an electric vehicle. Accordingly, the socket 2 is a charging socket for the electric vehicle. Correspondingly, a plug is, for example, a charging gun that matches the charging socket of the electric vehicle.

In an embodiment, the connection terminals 3 are female terminals. Paired terminals which are provided on the charging gun and plugged into the connection terminals 3 are male terminals, such that the connection terminals 3 are capable of forming a paired connection with the paired terminals which are provided on the charging gun and are plugged thereto.

The multiple connection terminals 3 are used to electrically connect the paired terminals on the car battery pack and charging gun. The number and specifications of the connecting terminals 3 are selected according to the needs. Specifically, as an example, the multiple second wall portions 13 and corresponding terminals 3 are arranged to be adapted one-to-one. The connecting terminal 3 is accommodated within the corresponding mounting hole defined by the corresponding second wall portion 13.

The plurality of connection terminals 3 are used for electrically connecting with paired terminals on a battery pack of an automobile e.g., an electric vehicle and on a charging gun. In an embodiment, the plurality of second wall portions 13 and corresponding terminals 3 are arranged in one-to-one correspondence. The number and specification of the connection terminals 3 should be selected as per requirement. In an exemplary embodiment, the plurality of second wall portions 13 and corresponding terminals are arranged to be adapted in one-to-one correspondence.

The connecting terminals 3 are accommodated within corresponding installation holes defined by respective second wall portions 13. In the embodiment, the plurality of connection terminals 3 are used for implementing the following electrical connections: a positive pole DC+of a DC power supply is electrically connected with a respective paired terminal; a negative pole DC-of the DC power supply is electrically connected with a respective paired terminal; a protective grounding terminal PE, i.e., GND, is electrically connected with a respective paired terminal; a charging communication positive pole S+ is electrically connected with a respective paired terminal; a charging communication negative pole S—is electrically connected with a respective paired terminal; a first charging connection confirmation terminal CC1 is electrically connected with a respective paired terminal; a second charging connection confirmation terminal CC2 is electrically connected with a respective paired terminal; a positive pole A+ of an auxiliary power supply is electrically connected with a respective paired terminal; a negative pole A—of the auxiliary power supply is electrically connected with a respective paired terminal. These nine types of connection terminals 3 can meet the requirements on electrical connection of the relevant Chinese national standards for the DC charging interface in the connection device for electric vehicle transmission charging. Specific device structure, circuit connection and operation principle will not be repeatedly set forth herein.

In an embodiment, as shown in FIG. 4B, the base portion 10 is at a predetermined first angle a1 relative to the sheet metal component 4, and the first drainage portion 12 is inclined at an acute angle within an angular range greater than the first angle a1 with respect to an axial direction of the first wall portion 11.

In an exemplary embodiment, the first angle a1 is a preset angle depending on specific installation position of the socket housing 1 as illustrated, and is typically an acute angle, for example, it may be 15 degrees inclined relative to a vertical direction (i.e., a direction of a plumb line). The socket housing 1 is installed slightly upwards relative to the sheet metal component of the vehicle body, thus conforming to the installation context of the socket 2 in specific application of the design of the vehicle body, and facilitating a smooth insertion of the plug, i.e., the charging gun, into the socket 2 so as to be fitted in place for charging and then unplugging from the socket 2 for removal, which is in line with ergonomic requirements.

In an embodiment, the angle at which the first drainage portion 12 is inclined relative to the axial direction of the first wall portion 11 (referred to as a second angle a2) cannot be too small. If the second angle a2 is smaller than the first angle a1, water cannot be drained smoothly, resulting in that the accumulated water may remain in the space enclosed jointly by the first wall portion 11 and the base portion 10. Moreover, the second angle a2 cannot be too large; the first wall portion 11 is formed by opening holes in the socket housing 1 which is molded from plastic integratedly, and a difficulty in processing would be increased, or even upon further consideration of a relative complex internal design of the first drainage portion 12, it may be impossible to process. Therefore, upon a comprehensive consideration, by way of example, any angle selected from all angles within a second angular range may function as the second angle a2, for example an acute angle slightly larger than the first angle a1, e.g., not exceeding/beyond twice of the first angle a1. Typically, by way of example in a condition that the first angle a1 may be 15 degrees inclined with respect to the vertical direction or a direction of a plumb line, then, a maximum angular value in the second angular range may for example be 30 degrees.

As such, by such a setting for the first angle a1 and the second angular range, a compromise among convenient processing of the first drainage portion 12, the ergonomics of the installation environment of the socket 2 as well as the plugging and unplugging operation, and the smoothness of drainage can in turn be achieved at the same time.

In an exemplary embodiment according to the present disclosure, the dimension of the cross section of the first drainage portion 12 may, for example, depend on the first angle a1 and the second angular range. As to the structure of the first drainage portion 12, an overall inclination thereof, especially at the inlet portion 121, may have an impact on the flow rate, and is therefore a factor to be taken into consideration in the design of the cross section.

According to the radial dimension and circumferential dimension of the first wall portion 11, and even upon consideration of the first angle a1 and the second angular range, a specific shape of the cross section for the first drainage portion 12 and dimension thereof merely requires to ensure that there exists a passage through which the accumulated water enclosed by the first wall portion 11 and the base portion 10 may be drained and discharged under the action of gravity.

Therefore, in the above disclosure, and also based on the angular setting of the first angle al and the second angular range, a compromise among convenient processing of the first drainage portion 12, the ergonomics of the installation environment of the first drainage portion 12 as well as the plugging and unplugging operation, and the smoothness of drainage can in turn be achieved simultaneously.

In an embodiment, in order to enhance the protection of the installation holes and the connection terminals 3 accommodated in respective installation holes, the socket housing 1 also has a stopper. Each second wall portion 13 may be provided with a stopper protruding radially inwards at a free end thereof, and the stopper may be configured to prevent the terminal 3 from being separated from the hole defined by the second wall portion 13. Specifically, by way of example, each stopper is provided with a continuous inner peripheral surface, and each stopper extends in a closed loop shape along a circumferential direction of a respective second wall portion 13.

In an embodiment, the socket 2 further includes, for example, an elastic sealing sleeve sleeved on a rear end of the terminals 3, which is squeezed between the outer walls of the terminals 3 and the inner walls of the installation holes for inserting the terminals 3, so as to seal the mating interface therebetween. As such, water can be further prevented from flowing into an assembly of the sheet metal component 4 at the rear of the socket 2.

As shown in FIG. 4A, in an embodiment as illustrated, the base portion 10 is coupled to the sheet metal component 4 at the second side thereof via at least one of a snap fit and a threaded connection.

In another exemplary embodiment, the socket 2 may selectively additionally be provided with an external drainage pipe which communicates with the outlet section 122 of the first drainage portion 12, for example, being coupled to an electric pump, so as to further facilitate rapid drainage.

The socket housing 1 and the socket 2 in the aforementioned embodiments can be used for charging electric vehicles or other electric equipment. The above description is intended to be illustrative, not restrictive. The embodiments illustrated in the attached drawings are intended to illustrate embodiments of the utility model and should not be understood as a limitation of the utility model. Those skilled in the art will understand that modifications can be made without departing from the principles and spirit of the general concept of this disclosure of the utility model, and the structures described in various embodiments can be freely combined without conflicts in structure or principle.

The breadth and scope of the utility model should not be limited by any of the above-mentioned exemplary embodiments and should be limited merely by the following claims and their equivalents.

It should be noted that the wording “comprising” does not exclude other elements or steps, and the wording “a” or “an” does not exclude multiple. In addition, reference numerals for any element in the claims should not be construed as limiting the scope of the utility model.

What is claimed is:

1. A socket housing, comprising:
a base portion; and
a first wall portion formed as a hollow cylindrical wall that protrudes continuously from a first side of the base portion, the first wall portion has a first drainage portion intersecting the base portion and opening outwards, the first drainage portion is a passage that extends obliquely from an inner root portion of the first wall portion to an outer root portion of the first wall portion.

2. The socket housing of claim 1, further comprising a plurality of second wall portions surrounded by the first wall portion and spaced apart from each other.

3. The socket housing of claim 2, wherein each of the second wall portions is formed as a hollow cylindrical wall protruding continuously from the first side of the base portion.

4. The socket housing of claim 3, wherein each second wall portion has a second drainage portion at an intersection of the second wall portion with the base portion, the second drainage portion is a passage that extends from an inner side to an outer side of the second wall portion.

5. The socket housing of claim 4, wherein the second drainage portion extends continuously along an axial direction of the second wall portion to a free end of the second wall portion.

6. The socket housing of claim 3, wherein the first drainage portion extends continuously from an inlet section of the first wall portion to an outlet section of the first wall portion, the inlet section is at an intersection of the inner root portion with the base portion, the outlet section is at an intersection of the outer root portion with the base portion.

7. The socket housing of claim 6, wherein the first drainage portion has a plurality of channel sections coupled with each other, an angle of each of the channel sections relative to an axial direction of the first wall portion gradually increases from the inlet section toward the outlet section.

8. The socket housing of claim 7, wherein the inlet section has a groove extending along the axial direction of the first wall portion and has a cross section gradually increasing from an inner side towards an outer side of the first wall portion.

9. The socket housing of claim 8, wherein the groove has a guide inclined surface at a bottom portion of the groove, a higher end of the guide inclined surface is distal to the inlet section and a lower end of the guide inclined surface is proximal to the inlet section.

10. The socket housing of claim 7, wherein the outlet section has an inverted funnel shape with a cross-section that expands outwards.

11. The socket housing of claim 10, wherein, before the outlet section, the first drainage portion has a cross-sectional area gradually decreasing from the inlet section towards the outlet section.

12. The socket housing of claim 7, wherein the first drainage portion has a turning section extending outwards before the outlet section.

13. The socket housing of claim 7, wherein a plurality of rounded corners are formed at a plurality of edges of both the inlet section and the outlet section.

14. The socket housing of claim 7, wherein the outlet section has a protective portion at least partially surrounding itself.

15. The socket housing of claim 1, wherein the base portion and the first wall portion are integrally molded plastic pieces.

16. A socket for coupling to a sheet metal component of a vehicle body, comprising:
a socket housing including a base portion and a first wall portion formed as a hollow cylindrical wall that protrudes continuously from a first side of the base portion, the first wall portion has a first drainage portion intersecting the base portion and opening outwards, the first drainage portion is a passage that extends obliquely from an inner root portion of the first wall portion to an outer root portion of the first wall portion, a second side of the base portion opposite to the first side is arranged toward the sheet metal component and coupled to the sheet metal component; and
a plurality of connection terminals respectively accommodated in a plurality of holes defined by a plurality of second wall portions of the socket housing.

17. The socket of claim 16, wherein the base portion is at a first angle relative to the sheet metal component, the first drainage portion is inclined at an acute angle within an angular range greater than the first angle with respect to an axial direction of the first wall portion.

18. The socket of claim 16, wherein each of the second wall portions has a stopper protruding radially inwards at a free end of the second wall portion, the stopper prevents one of the connection terminals from being separated from the one of the holes defined by the second wall portion.

19. The socket of claim 18, wherein the stopper has a continuous inner peripheral surface, each stopper extends in a closed loop shape along a circumferential direction of one of the second wall portions.

20. The socket of claim 16, wherein the base portion is coupled to the sheet metal component by at least one of a snap fit and a threaded connection.
